(19) United States
(12) Patent Application Publication
(10) Pub. No.: US 2023/0270039 A1
(43) Pub. Date: Aug. 31, 2023

(54) AGRICULTURAL IMPLEMENTS HAVING ROW UNIT POSITION SENSORS AND ACTUATORS CONFIGURED TO ROTATE TOOLBARS, AND RELATED CONTROL SYSTEMS AND METHODS

(71) Applicant: AGCO Corporation, Duluth, GA (US)

(72) Inventors: Benjamin Anson FANSHIER, Hesston, KS (US); Monte J. Rans, Hesston, KS (US); Ross Duerksen, Hesston, KS (US); Zane Wesley Unrau, Hesston, KS (US); Robert L. Figger, Hesston, KS (US)

(21) Appl. No.: 17/818,892

(22) PCT Filed: Feb. 17, 2021
(86) PCT No.: PCT/IB2021/051311

§ 371 Date: Aug. 10, 2022

Related U.S. Application Data
(60) Provisional application No. 63/007,182, filed on Apr. 8, 2020.

(51) Int. Cl. A01B 79/00; A01B 63/00

(52) U.S. Cl. CPC A01B 79/005; A01B 63/008; A01B 79/02

(57) ABSTRACT

An agricultural implement includes a longitudinally extending frame configured to be coupled to a tractor, a first elongate toolbar extending laterally outward from the frame and carrying a first row unit, a second elongate toolbar extending laterally outward the frame and carrying a second row unit, a first sensor configured to sense a position of the first row unit relative to ground, a second sensor configured to sense a position of the second row unit relative to the ground, a first actuator configured to rotate the first elongate toolbar relative to the frame based at least in part on the sensed position of the first row unit, and an actuator configured to rotate the second elongate toolbar relative to the frame based at least in part on the sensed position of the second row unit. Control systems and related methods are also disclosed.

### CROSS-REFERENCE TO RELATED APPLICATION

This application claims the benefit of the filing date of U.S. Provisional Patent Application 63/007,182, “Agricultural Implements Having Row Unit Position Sensors and Actuators Configured to Rotate Toolbars, and Related Control Systems and Methods,” filed Apr. 8, 2020, the entire disclosure of which is incorporated herein by reference.

### FIELD

Embodiments of the present disclosure relate generally to machines and methods for working agricultural fields. In particular, embodiments relate to implements (e.g., planters, tillage, etc.) and to methods of controlling such implements.

### BACKGROUND

Crop yields are affected by a variety of factors, such as seed placement, soil quality, weather, irrigation, and nutrient applications. Seeds are typically planted in trenches formed by discs or other mechanisms of a planter row unit. Depth of seed placement is important because seeds planted at different depths emerge at different times, resulting in uneven crop growth, Trench depth can be affected by soil type, moisture level, row unit speed, and operation of the opening discs. It would be beneficial to have improved methods of controlling the location of planter row units so that seeds can be more precisely placed in a field.

### BRIEF SUMMARY

In some embodiments, an agricultural implement includes a longitudinally extending frame configured to be coupled to a tractor at a first end thereof, a first elongate toolbar extending laterally outward from a second end of the frame and carrying a first ground-engaging row unit, a second elongate toolbar extending laterally outward from the second end of the frame and carrying a second ground-engaging row unit, a first sensor configured to sense a position of the first ground-engaging row unit relative to the ground, a second sensor configured to sense a position of the second ground-engaging row unit relative to the ground, a first actuator configured to rotate the first elongate toolbar relative to the frame based at least in part on the sensed position of the first ground-engaging row unit, and an actuator configured to rotate the second elongate toolbar relative to the frame based at least in part on the sensed position of the second ground-engaging row unit.

Other embodiments include a control system for an implement including a longitudinally extending frame, a first elongate toolbar extending laterally outward from the frame and carrying a first ground-engaging row unit, and a second elongate toolbar extending laterally outward from the frame and carrying a second ground-engaging row unit. The control system includes a first actuator connecting the first elongate toolbar to the frame, a second actuator connecting the second elongate toolbar to the frame, a first sensor configured to sense a position of the first ground-engaging row unit relative to ground, a second sensor configured to sense a position of the second ground-engaging row unit relative to ground, and a controller. The controller is configured to receive a first signal from the first sensor indicating the position of the first ground-engaging row unit relative to the ground and a second signal from the second sensor indicating the position of the second ground-engaging row unit relative to the ground. The controller is configured to cause the first actuator to raise or lower the first elongate toolbar based on the sensed position of the first ground-engaging row unit and to cause the second actuator to raise or lower the second elongate toolbar based on the sensed position of the second ground-engaging row unit.

Certain embodiments include a computer-implemented method for operating an implement that includes a longitudinally extending frame, a first elongate toolbar extending laterally outward from the frame and carrying a first ground-engaging row unit, and a second elongate toolbar extending laterally outward from the frame and carrying a second ground-engaging row unit. The method includes receiving an indication of a position of the first ground-engaging row unit relative to the ground sensed by a first sensor, receiving an indication of a position of the second ground-engaging row unit relative to the ground sensed by a second sensor, causing a first actuator to raise or lower the first elongate toolbar relative to the frame based at least in part on the indication of the position of the first ground-engaging row unit, and causing a second actuator to raise or lower the second elongate toolbar relative to the frame based at least in part on the indication of the position of the second ground-engaging row unit.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments when read in conjunction with the accompanying drawings, in which:

FIG. 1 is a simplified top view of a tractor pulling an implement in accordance with one embodiment;

FIG. 2 is a simplified side view of row unit that may be carried by the implement shown in FIG. 1;

FIG. 3 is a simplified rear view the implement shown in FIG. 1 on level ground;

FIG. 4 is a simplified rear view the implement shown in FIG. 1 on sloped ground;

FIG. 5 is a simplified rear view the implement shown in FIG. 1 on sloped ground;

FIG. 6 is a simplified rear view another implement on sloped ground;

FIG. 7 is a simplified flow chart illustrating a method of operating an implement; and

FIG. 8 illustrates an example computer-readable storage medium comprising processor-executable instructions configured to embody one or more methods of operating an implement, such as the method illustrated in FIG. 7.

### DETAILED DESCRIPTION

The illustrations presented herein are not actual views of any implement or portion thereof, but are merely idealized representations that are employed to describe example embodiments of the present disclosure. Additionally, elements common between figures may retain the same numerical designation.

The following description provides specific details of embodiments of the present disclosure in order to provide a thorough description thereof. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. Also note, the drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

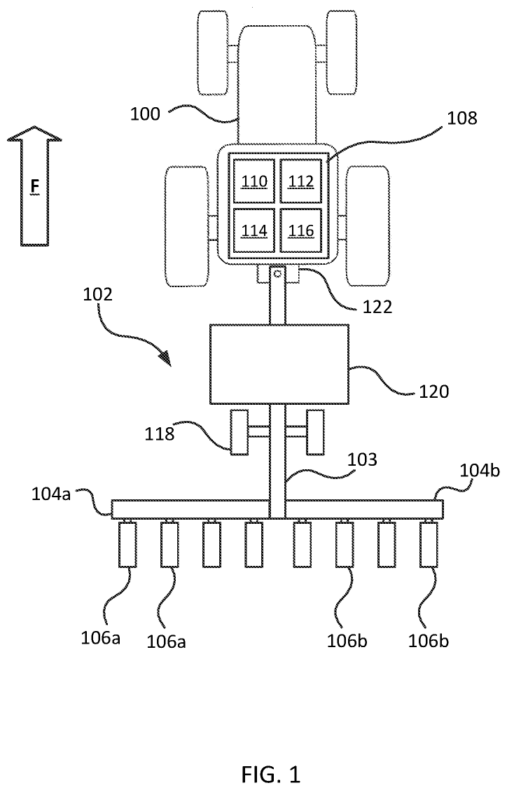

FIG. 1 illustrates a tractor 100 drawing an agricultural implement 102, which has a frame 103 extending longitudinally in a direction parallel to forward direction F along which the agricultural implement 102 travels while working a field. The frame 103 is configured to connect at the forward end to the tractor 100 at a tow hitch 122. A first elongate toolbar 104a and a second elongate toolbar 104b extend laterally outward from the rearward end of the frame 103. Row units 106a are carried by the first elongate toolbar 104a, and row units 106b are carried by the second elongate toolbar. The toolbars 104a, 104b and the row units 106a, 106b may be referred to below as simply the toolbar(s) 104 and the row unit(s) 106, respectively. A computer 108, which may include a central processing unit (“CPU”) 110, memory 112, implement controller 114, and graphical user interface (“GUI”) (e.g., a touch-screen interface), is typically located in the cab of the tractor 100. A global positioning system (“GPS”) receiver 116 may be mounted to the tractor 100 and connected to communicate with the computer 108. The computer 108 may include an implement controller 114 configured to communicate with the row units 106 and/or the GPS receiver 116, such as by wired or wireless communication. The implement 102 may be supported in the field by at least one wheel 118 coupled to the frame 103. Typically, the frame 103 is attached to at least two wheels 118.

The frame 103 may carry a material hopper 120 configured to provide material to the row units 106 (e.g., seeds, fertilizer, etc.). The wheels 118 may support substantially all of the weight of the implement 102, including material in the hopper 120. In some embodiments, the tractor 100 may support a portion of the weight of the implement 102 via the tow hitch 122 thereon. Typically, the row units 106 do not support significant weight of the implement 102, though the row units 106 may exert a force on the ground during operation.

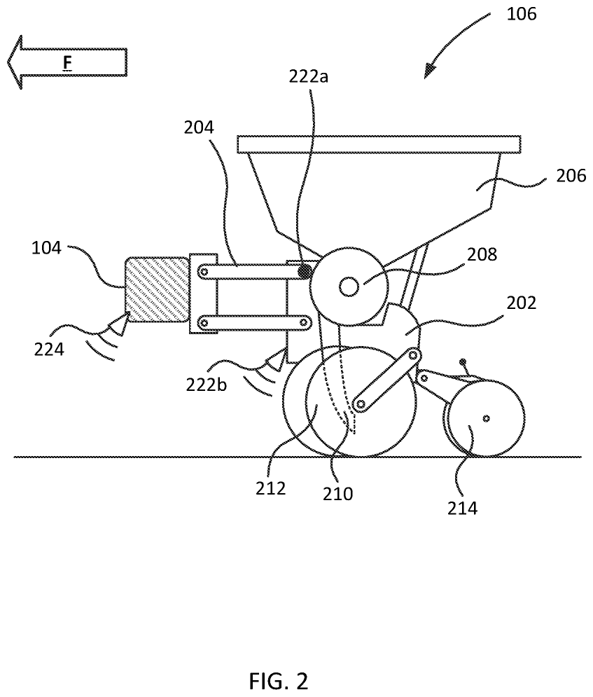

The row units 106 may be any type of ground-engaging device for planting, seeding, fertilizing, tilling, or otherwise working crops or soil, typically in rows. As an example, FIG. 2 is a simplified side view illustrating a single row unit 106 in the form of a planter row unit. The row unit 106 has a body 202 pivotally connected to the toolbar 104 by a parallel linkage 204, enabling the row unit 106 to move vertically independent of the toolbar 104. In some embodiments, the body 202 of the row unit 106 may be connected to the toolbar 104 by another structure, such as a rotating arm. The body 202 may be a unitary member, or may include one or more members coupled together (e.g., by bolts, welds, etc.). The body 202 operably supports one or more hoppers 206, a seed meter 208, a seed delivery mechanism 210, a seed trench opening assembly 212, a trench closing assembly 214, and any other components as known in the art. It should be understood that the row unit 106 shown in FIG. 2 may optionally be a part of a central fill planter, in which case the hoppers 206 may be one or more mini-hoppers fed by the material hopper 120 (FIG. 1) carried by the implement 102. In other embodiments, the material hopper 120 may be omitted, and each row unit may simply use its own hopper 206 alone.

At least one sensor 222a and/or 222b may be used to determine a position of a row unit 106 relative to the ground. As shown in FIG. 2, the sensor(s) 222a, 222b may be carried on the body 202 of the row unit 106 itself. In other embodiments, sensor(s) may be carried by the toolbar 104, the frame 103 of the implement, the tractor 100, or even by another vehicle (e.g., another ground vehicle, an unmanned aerial vehicle, etc.). The sensor 222a may be a rotary sensor configured to measure an angle of an element of the parallel linkage 204 relative to the body 202 of the row unit 106 or to the toolbar 104, and may be connected to a pivot point of the body 202 of the row unit 106 or to the toolbar 104. The sensor 222b depicted may include a non-contact depth sensor, for example, an optical sensor, an ultrasonic transducer, an RF (radio frequency) sensor, lidar, radar, etc. Such sensors are described in, for example, U.S. Patent Application Publication 2019/0075710, “Seed Trench Depth Detection Systems,” published Mar. 14, 2019. The sensor(s) 222a, 222b may provide information that can be used to adjust the position of the toolbars 104a, 104b.

In some embodiments, an additional sensor 224 may be configured to detect the position of the toolbar 104 relative to the ground.

The implement 102 traveling through a field in the forward direction F may encounter variations in field elevation and/or slope. The sensor(s) 222, 224 detect the position of the row unit 106 and optionally, the toolbar 104, relative to the ground surface, and send signals to the implement controller 114 (FIG. 1).

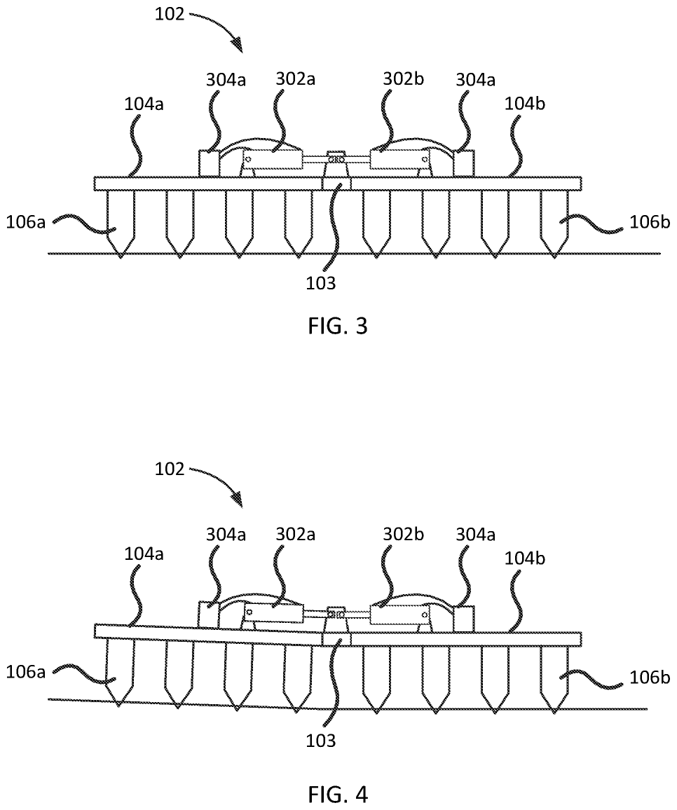

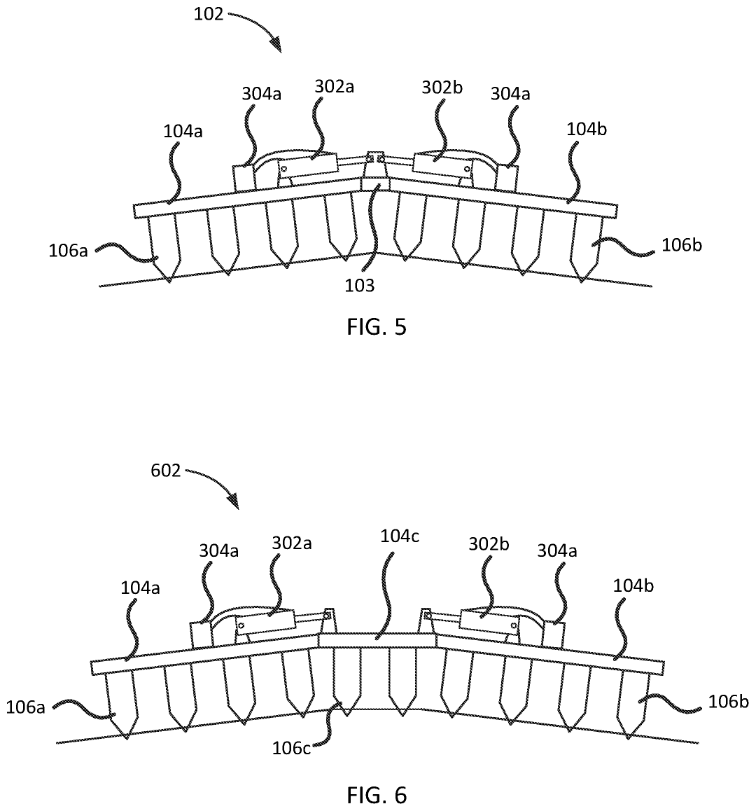

FIG. 3 shows a simplified rear view of the implement 102 traveling over level ground. The position of each toolbar 104a, 104b relative to the frame 103 may be controlled by actuators 302a, 302b. FIGS. 4 and 5 show simplified rear views of the implement 102 traveling over sloped ground, and illustrates how the implement 102 may adjust to different terrain. In FIG. 4, the ground at the left-hand side is sloped upward from the center, and the ground at the right-hand side is level. In FIG. 5, the ground is sloped downward from the center in both directions. Implements with toolbar sections that can move relative to one another to match different terrain are described in more detail in U.S. Pat. No. 10,582,654, “Implement Load Balancing System,” issued Mar. 10, 2020.

To account for the contour of the ground, as detected by the sensor(s) 222, 224 (FIG. 2), the actuator 302a shortens, raising the toolbar 104a. The parallel linkages 204 (FIG. 2) of each row unit 106 may also adjust the depth at which an individual row unit 106 operates (e.g., plants seeds) in the ground.

The actuators 302a, 302b may each adjust the orientations of the toolbars 104a, 104b such that the row units 106a, 106b and/or the toolbars 104a, 104b remain at a preselected position with respect to the ground. That is, in addition to the parallel linkages 204, which are adjustable on a per-row-unit basis, the actuators 302a, 302b may adjust the angle of the toolbars 104a, 104b relative to the frame 103. That is, the row units 106a, 106b may be adjusted by moving the outboard ends of the toolbars 104a, 104b upward or downward (i.e., by moving the actuators 302a, 302b) and by moving the row units 106a, 106b with respect to the toolbars 104a, 104b (i.e., by rotating the parallel linkages 204). Thus, each row unit 106 may exhibit a wider total range of motion than an implement 102 having only the parallel linkage 204 to adjust the height of the row unit 106 with respect to the toolbar 104.

Furthermore, the actuators 302a, 302b may transfer the weight of the toolbars 104a, 104b and the row units 106a, 106b to the frame 103, and therefore to the wheels 118 supporting the frame 103. If the actuators 302a, 302b have sufficient capacity to support the entire weight of the toolbars 104a, 104b and row units 106a, 106b, wheels supporting outboard ends of the toolbars 104a, 104b may be omitted, avoiding ground compaction that would be caused by such wheels.

The actuators 302a, 302b may be controlled by the implement controller 114 via one or more control components 304a, 304b (illustrated as rectangular boxes connected to the actuators 302a, 302b) such as control valves, air valves, electronic control components, magnetic control components, or electromagnetic control components, etc. The controller 114 may send a signal to the control components 304a, 304b to implement changes in the positions of the actuators 302a, 302b.

Typically, there may be multiple row units 106 on each toolbar 104. Thus, movement of one actuator 302 typically changes the position of the multiple row units 106. The implement controller 114 may calculate an appropriate position of each actuator 302 so that the row units 106 on a toolbar 104 can each be at a preselected depth when accounting for the position of each corresponding parallel linkage 204. That is, the controller 114 may select an actuator position such that the row units 106 can each be adjusted to be at a preselected depth. The actuators 302a, 302b may enable a wider range of operating conditions (e.g., maximum field slope variation) than conventional wing control systems and may enable the implement controller 114 to respond more quickly to changing field terrain, without the need for support from wheels at the outboard ends of the toolbars 104a, 104b.

FIG. 6 shows a simplified rear view of another implement 602 traveling over sloped ground. The implement 602 is similar to the implement 102, but also includes an integral center toolbar 104c and row units 106c carried by the integral center toolbar 104c. The integral center toolbar 104c may be fixed with respect to the frame 103, and the toolbars 104a, 104b may be rotatably coupled to the ends of the integral center toolbar 104c. The actuators 302a, 302b may couple the toolbars 104a, 104b, respectively, to the integral center toolbar 104c.

Though the implement 102 is described herein as a planter, the implement 102 may be any type of implement having row units, such as tillage implements (e.g., disc harrows, chisel plows, field cultivators, etc.) and seeding tools (e.g., grain drills, disc drills, etc.).

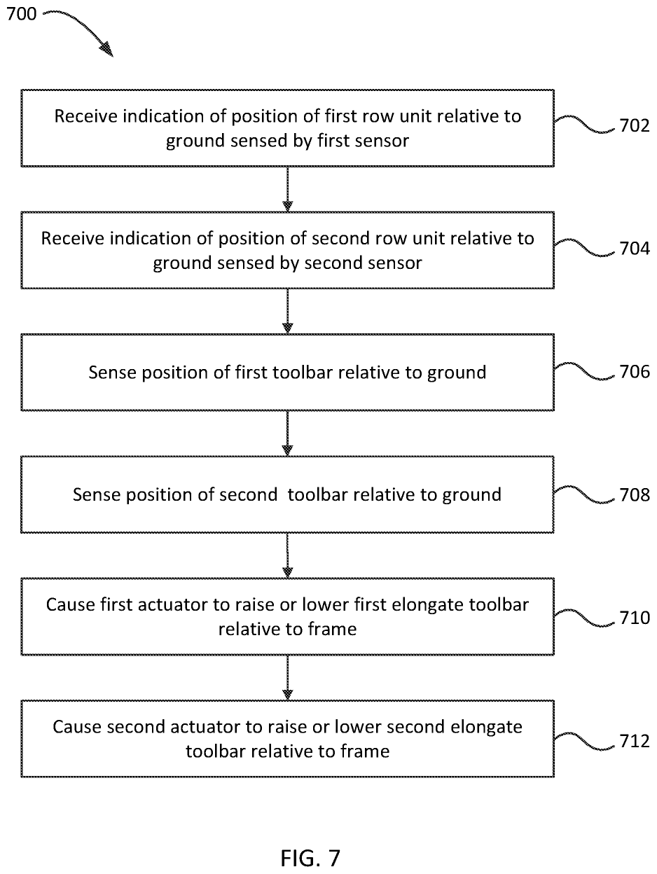

FIG. 7 is a simplified flow chart illustrating a computer-implemented method 700 of using the implement 102, 602 to work an agricultural field. In block 702, an indication is received of a position of a first row unit relative to the ground sensed by a first sensor. In block 704, an indication is received of a position of a second row unit relative to the ground sensed by a second sensor. For example, signals from the sensors may be received by a controller. In block 706, a position of a first toolbar is optionally sensed relative to the ground. In block 708, a position of a second toolbar is optionally sensed relative to the ground. In block 710, a first actuator raises or lowers the first toolbar, which raising or lowering may be based at least in part on the position of the first row unit, and optionally in part on the sensed position of the first toolbar. In block 712, a second actuator raises or lowers the second toolbar, which raising or lowering may be based at least in part on the position of the second row unit, and optionally in part on the sensed position of the second toolbar. For example, signals may be sent to a control component associated with the actuators.

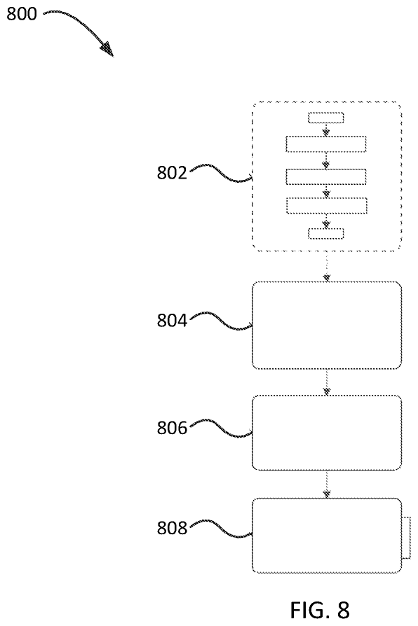

Still other embodiments involve a computer-readable storage medium (e.g., a non-transitory computer-readable storage medium) having processor-executable instructions configured to implement one or more of the techniques presented herein. An example computer-readable medium that may be devised is illustrated in FIG. 8, wherein an implementation 800 includes a computer-readable storage medium 802 (e.g., a flash drive, CD-R, DVD-R, application-specific integrated circuit (ASIC), field-programmable gate array (FPGA), a platter of a hard disk drive, etc.), on which is computer-readable data 804. This computer-readable data 804 in turn includes a set of processor-executable instructions 806 configured to operate according to one or more of the principles set forth herein. In some embodiments, the processor-executable instructions 806 may be configured to cause a computer associated with the tractor 100 (FIG. 1) to perform operations 808 when executed via a processing unit, such as at least some of the example method 700 depicted in FIG, 7. In other embodiments, the processor-executable instructions 806 may be configured to control a system, such as at least some of the example tractor 100 and implement 102 depicted in FIG. 1. Many such computer-readable media may be devised by those of ordinary skill in the art that are configured to operate in accordance with one or more of the techniques presented herein.

Additional non limiting example embodiments of the disclosure are described below.

Embodiment 1: An agricultural implement comprising a longitudinally extending frame configured to be coupled to a tractor at a first end thereof, a first elongate toolbar extending laterally outward from a second end of the frame and carrying a first ground-engaging row unit, a second elongate toolbar extending laterally outward from the second end of the frame and carrying a second ground-engaging row unit, a first sensor configured to sense a position of the ground-engaging first row unit relative to ground, a second sensor configured to sense a position of the second ground-engaging row unit relative to the ground, a first actuator configured to rotate the first elongate toolbar relative to the frame based at least in part on the sensed position of the first ground-engaging row unit, and an actuator configured to rotate the second elongate toolbar relative to the frame based at least in part on the sensed position of the second ground-engaging row unit.

Embodiment 2: The implement of Embodiment 1, wherein the first ground-engaging row unit is coupled to the first elongate toolbar by a first parallel linkage, and wherein the second ground-engaging row unit is coupled to the second elongate toolbar by a second parallel linkage.

Embodiment 3: The implement of Embodiment 2, wherein the first sensor comprises a rotary sensor configured to measure an angle of an element of the first parallel linkage, and wherein the second sensor comprises a rotary sensor configured to measure an angle of an element of the second parallel linkage.

Embodiment 4: The implement of Embodiment 1 or Embodiment 2, wherein the first sensor and the second sensor each comprise an ultrasonic, lidar, or radar sensor.

Embodiment 5: The implement of any one of Embodiment 1 through Embodiment 4, further comprising a controller configured to receive a first signal from the first sensor and a second signal from the second sensor, and control the first actuator based on the first signal and the second actuator based on the second signal.

Embodiment 6: The implement of Embodiment 5, further comprising a first control component configured to drive the first actuator and a second control component configured to drive the second actuator, wherein the controller is configured to send control signals to the control components.

Embodiment 7: The implement of Embodiment 6, wherein the control components each comprise a component selected from the group consisting of a control valve, an air valve, an electronic control component, a magnetic control component, and an electromagnetic control component.

Embodiment 8: The implement of any one of Embodiment 1 through Embodiment 7, further comprising a third sensor configured to sense a position of the first toolbar relative to the ground and a fourth sensor configured to sense a position of the second toolbar relative to the ground.

Embodiment 9: The implement of Embodiment 8, wherein the first actuator is configured to raise and lower the first toolbar relative to the frame based in part on the sensed position of the first toolbar relative to the ground, and wherein the second actuator is configured to raise and lower the second toolbar relative to the frame based in part on the sensed position of the second toolbar relative to the ground.

Embodiment 10: The implement of any one of Embodiment 1 through Embodiment 9, wherein the frame comprises an integral elongate toolbar.

Embodiment 11: The implement of Embodiment 10, wherein the first and second elongate toolbars are each rotatably coupled to the integral elongate toolbar of the frame.

Embodiment 12: A control system for an implement comprising a longitudinally extending frame, a first elongate toolbar extending laterally outward from the frame and carrying a first ground-engaging row unit, and a second elongate toolbar extending laterally outward from the frame and carrying a second ground-engaging row unit. The control system comprises a first actuator connecting the first elongate toolbar to the frame, a second actuator connecting the second elongate toolbar to the frame, a first sensor configured to sense a position of the first ground-engaging row unit relative to ground, a second sensor configured to sense a position of the second ground-engaging row unit relative to the ground, and a controller configured to receive a first signal from the first sensor indicating the position of the first ground-engaging row unit relative to the ground and a second signal from the second sensor indicating the position of the second ground-engaging row unit relative to the ground. The controller is configured to cause the first actuator to raise or lower the first elongate toolbar based on the sensed position of the first ground-engaging row unit and to cause the second actuator to raise or lower the second elongate toolbar based on the sensed position of the second ground-engaging row unit.

Embodiment 13: The control system of Embodiment 12, further comprising a first control component configured to drive the first actuator and a second control component configured to drive the second actuator. The controller is configured to send control signals to the control components.

Embodiment 14: The control system of Embodiment 13, wherein the control components each comprise a component selected from the group consisting of a control valve, an air valve, an electronic control component, a magnetic control component, and an electromagnetic control component.

Embodiment 15: The control system of any one of Embodiment 12 through Embodiment 14, further comprising a third sensor configured to sense a position of the first toolbar relative to the ground and a fourth sensor configured to sense a position of the second toolbar relative to the ground.

Embodiment 16: A computer-implemented method for operating an implement that comprises a longitudinally extending frame, a first elongate toolbar extending laterally outward from the frame and carrying a first ground-engaging row unit, and a second elongate toolbar extending laterally outward from the frame and carrying a second ground-engaging row unit. The method comprises receiving an indication of a position of the first ground-engaging row unit relative to ground sensed by a first sensor, receiving an indication of a position of the second ground-engaging row unit relative to the ground sensed by a second sensor, causing a first actuator to raise or lower the first elongate toolbar relative to the frame based at least in part on the indication of the position of the first ground-engaging row unit, and causing a second actuator to raise or lower the second elongate toolbar relative to the frame based at least in part on the indication of the position of the second ground-engaging row unit.

Embodiment 17: The method of Embodiment 16, further comprising sensing a position of the first toolbar relative to the ground and sensing a position of the second toolbar relative to the ground.

Embodiment 18: The method of Embodiment 16 or Embodiment 17, wherein causing the first actuator to raise or lower the first toolbar relative to the frame comprises sending a first control signal to a first control component associated with the first actuator, and wherein causing the second actuator to raise or lower the second toolbar relative to the frame comprises sending a second control signal to a second control component associated with the second actuator.

Embodiment 19: The method of any one of Embodiment 16 through Embodiment 18, wherein receiving the indication of the first position of the first ground-engaging row unit relative to the ground sensed by the first sensor comprises receiving a first signal from the first sensor, and wherein receiving the indication of the second position of the second ground-engaging row unit relative to the ground sensed by the second sensor comprises receiving a second signal from the second sensor.

The structures and methods shown and described herein may be used in conjunction with those shown in U.S. Provisional Patent Application 60/007,114, “Agricultural Implements Having Row Unit Position Sensors and at Least One Adjustable Wheel, and Related Control Systems and Methods,” filed Apr. 8, 2020; U.S. Provisional Patent Application 63/007,130, “Systems Comprising Agricultural Implements Connected to Lifting Hitches and Related Control Systems and Methods,” filed Apr. 8, 2020; and U.S. Provisional Patent Application 63/007,152, “Agricultural Implements Having Row Unit Position Sensors and a Rotatable Implement Frame, and Related Control Systems and Methods.” All references cited herein are incorporated herein in their entireties. If there is a conflict between definitions herein and in an incorporated reference, the definition herein shall control.

While the present invention has been described herein with respect to certain illustrated embodiments, those of ordinary skill in the art will recognize and appreciate that it is not so limited. Rather, many additions, deletions, and modifications to the illustrated embodiments may be made without departing from the scope of the invention as hereinafter claimed, including legal equivalents thereof. In addition, features from one embodiment may be combined with features of another embodiment while still being encompassed within the scope of the invention as contemplated by the inventors. Further, embodiments of the disclosure have utility with different and various agricultural machine types and configurations.

1. An agricultural implement, comprising:
a longitudinally extending frame configured to be coupled to a tractor at a first end thereof;
a first elongate toolbar extending laterally outward from a second end of the frame and carrying a first ground-engaging row unit;
a second elongate toolbar extending laterally outward from the second end of the frame and carrying a second ground-engaging row unit;
a first sensor configured to sense a position of the first ground-engaging row unit relative to ground;
a second sensor configured to sense a position of the second ground-engaging row unit relative to the ground;
a first actuator configured to rotate the first elongate toolbar relative to the frame based at least in part on the sensed position of the first ground-engaging row unit; and
a second actuator configured to rotate the second elongate toolbar relative to the frame based at least in part on the sensed position of the second ground-engaging row unit.

2. The implement of claim 1, wherein the first ground-engaging row unit is coupled to the first elongate toolbar by a first parallel linkage, and wherein the second ground-engaging row unit is coupled to the second elongate toolbar by a second parallel linkage.

3. The implement of claim 2, wherein the first sensor comprises a rotary sensor configured to measure an angle of an element of the first parallel linkage, and wherein the second sensor comprises a rotary sensor configured to measure an angle of an element of the second parallel linkage.

4. The implement of claim 1, wherein the first sensor and the second sensor each comprise an ultrasonic, lidar, or radar sensor.

5. The implement of claim 1, further comprising a controller configured to:
receive a first signal from the first sensor and a second signal from the second sensor; and
control the first actuator based on the first signal and the second actuator based on the second signal.

6. The implement of claim 5, further comprising a first control component configured to drive the first actuator and a second control component configured to drive the second actuator, wherein the controller is configured to send control signals to the control components.

7. The implement of claim 6, wherein the control components each comprise a component selected from the group consisting of a control valve, an air valve, an electronic control component, a magnetic control component, and an electromagnetic control component.

8. The implement of claim 1, further comprising a third sensor configured to sense a position of the first toolbar relative to the ground and a fourth sensor configured to sense a position of the second toolbar relative to the ground.

9. The implement of claim 8, wherein the first actuator is configured to raise and lower the first toolbar relative to the frame based in part on the sensed position of the first toolbar relative to the ground, and wherein the second actuator is configured to raise and lower the second toolbar relative to the frame based in part on the sensed position of the second toolbar relative to the ground.

10. The implement of claim 1, wherein the frame comprises an integral elongate toolbar.

11. The implement of claim 10, wherein the first and second elongate toolbars are each rotatably coupled to the integral elongate toolbar of the frame.

12. A control system for an implement comprising a longitudinally extending frame, a first elongate toolbar extending laterally outward from the frame and carrying a first ground-engaging row unit, and a second elongate toolbar extending laterally outward from the frame and carrying a second ground-engaging row unit, the control system comprising:
a first actuator connecting the first elongate toolbar to the frame;
a second actuator connecting the second elongate toolbar to the frame;
a first sensor configured to sense a position of the first ground-engaging row unit relative to ground;
a second sensor configured to sense a position of the second ground-engaging row unit relative to the ground; and
a controller configured to receive a first signal from the first sensor indicating the position of the first ground-engaging row unit relative to the ground and a second signal from the second sensor indicating the position of the second ground-engaging row unit relative to the ground, wherein the controller is configured to cause the first actuator to raise or lower the first elongate toolbar based on the sensed position of the first ground-engaging row unit and to cause the second actuator to raise or lower the second elongate toolbar based on the sensed position of the second ground-engaging row unit.

13. The control system of claim 12, further comprising a first control component configured to drive the first actuator and a second control component configured to drive the second actuator, wherein the controller is configured to send control signals to the control components.

14. The control system of claim 13, wherein the control components each comprise a component selected from the group consisting of a control valve, an air valve, an electronic control component, a magnetic control component, and an electromagnetic control component.

15. The control system of claim 1, further comprising a third sensor configured to sense a position of the first toolbar relative to the ground and a fourth sensor configured to sense a position of the second toolbar relative to the ground.

16. A computer-implemented method for operating an implement that comprises a longitudinally extending frame, a first elongate toolbar extending laterally outward from the frame and carrying a first ground-engaging row unit, and a second elongate toolbar extending laterally outward from the frame and carrying a second ground-engaging row unit, the method comprising:
receiving an indication of a position of the first ground-engaging row unit relative to ground sensed by a first sensor;
receiving an indication of a position of the second ground-engaging row unit relative to the ground sensed by a second sensor;
causing a first actuator to raise or lower the first elongate toolbar relative to the frame based at least in part on the indication of the position of the first ground-engaging row unit; and
causing a second actuator to raise or lower the second elongate toolbar relative to the frame based at least in part on the indication of the position of the second ground-engaging row unit.

17. The method of claim 16, further comprising sensing a position of the first toolbar relative to the ground and sensing a position of the second toolbar relative to the ground.

18. The method of claim 16, wherein causing the first actuator to raise or lower the first toolbar relative to the frame comprises sending a first control signal to a first control component associated with the first actuator, and wherein causing the second actuator to raise or lower the second toolbar relative to the frame comprises sending a second control signal to a second control component associated with the second actuator.

19. The method of claim 16, wherein receiving the indication of the first position of the first ground-engaging row unit relative to the ground sensed by the first sensor comprises receiving a first signal from the first sensor, and wherein receiving the indication of the second position of the second ground-engaging row unit relative to the ground sensed by the second sensor comprises receiving a second signal from the second sensor.
